(19) United States
(12) Patent Application Publication
(10) Pub. No.: US 2017/0181153 A1
(43) Pub. Date: Jun. 22, 2017

(54) METHOD AND DEVICE FOR TRANSMITTING CONTROL INFORMATION IN WIRELESS COMMUNICATION SYSTEM

(71) Applicant: LG ELECTRONICS INC., Seoul (KR)

(72) Inventors: Hyeyoung Choi, Seoul (KR); Heejeong Cho, Seoul (KR); Hyunsoo Ko, Seoul (KR); Ilmu Byun, Seoul (KR); Kyungmin Park, Seoul (KR)

(21) Appl. No.: 15/300,643

(22) PCT Filed: Mar. 24, 2015
(86) PCT No.: PCT/KR2015/002851

§ 371 Date: Sep. 29, 2016

Related U.S. Application Data
(60) Provisional application No. 61/972,404, filed on Mar. 30, 2014.

(51) Int. Cl. H04W 72/04; H04B 7/0417; H04W 72/06; H04W 72/08

(52) U.S. Cl. CPC H04W 72/048; H04W 72/0413; H04W 72/085; H04B 7/0417; H04W 72/06; H04W 84/12

(57) ABSTRACT

Disclosed are a method and a device for transmitting control information in a wireless communication system. A method for transmitting control information in a wireless communication system may comprise the steps of: transmitting, by a terminal, first cellular control information to a base station in a cellular system; and transmitting, by the terminal, second cellular control information to the base station through an AP in a wireless LAN system, wherein the terminal can communicate with the base station and the AP, and the first cellular control information and the second cellular control information may be control information for a service for the terminal of the base station.

### CROSS-REFERENCE TO RELATED APPLICATIONS

This application claims the benefit of priority of U.S. Provisional application No. 61/972,404 filed on Mar. 30, 2014, the contents of which are all hereby incorporated by reference herein their entirety.

### BACKGROUND OF THE INVENTION

Field of the Invention

The present invention relates to wireless communication and, more particularly, to a method and apparatus for transmitting control information in a wireless communication system.

Related Art

The universal mobile telecommunications system (UMTS) is a 3^{rd} generation asynchronous mobile communication system that operates in wideband code division multiple access (WCDMA) based on an European system, global system for mobile communications (GSM), and general packet radio services (GPRS). Long-term evolution (LTE) of the UMTS is being discussed by the 3^{rd} generation partnership project (3GPP) which standardizes the UMTS.

3GPP LTE is a technology for high-speed packet communication. Many methods have been suggested for objects of LTEs, including a reduction of user and supplier costs, the improvement of quality of service, and extended and improved coverage and system capacity. 3GPP LTE requires a reduced cost per bit, an increased service availability, flexible use of a frequency band, a simple structure, an open interface, and proper use of power for user equipment (UE) as upper-level requirements.

In 3GPP, access network discovery and selection functions (ANDSF) for discovering and selecting an access network that may be connected have been standardized while introducing interworking with non-3GPP access (e.g., a wireless local access network (WLAN)) from Rel-8. The ANDSF delivers information (e.g., WLAN or WiMAX location information) for discovering an access network which may be connected at the location of UE, inter-system mobility policies (ISMP) into which provider's policies may be incorporated, and an inter-system routing policy (ISRP). UE may determine that which IP traffic will be transmitted over which access network based on such information. The ISMP may include a network selection rule by which UE selects one activated access network connection (e.g., a WLAN or 3GPP). The ISRP may include a network selection rule by which UE selects one or more potential activated access network connections (e.g., both a WLAN and 3GPP). The ISRP may include multiple access connectivity (MAPCON), IP flow mobility (IFOM), and non-seamless WLAN offloading. For dynamic provision between the ANDSF and UE, open mobile alliance device management (OMA DM) may be used.

MAPCON is the standardization of a technology which establishes and maintains a plurality of packet data networks (PDN) connections at the same time through 3GPP access and non-3GPP access using different access point names (APNs) and which enables seamless traffic offloading of all of activated PDN connection units. MAPCON is a protocol-independent technology. Accordingly, proxy mobile IPv6 (PMIPv6), a GPRS tunneling protocol (GRP), and dual stack mobile IPv6 (DSMIPv6) may be used as the MAPCON. For the MAPCON, an ANDSF server may provide information about an APN which will perform offloading, a routing rule between access networks, the time of a day on which an offloading method is performed, and information about an access network (validity area) on which offloading will be performed.

IFOM is a DSMIPv6-based 3GPP/WLAN seamless offloading technology of an IP flow unit, which is more flexible and subdivided than MAPCON. DSMIPv6 supports both IPv4 and IPv6 in UE and a network. IFOM has adopts DSMIPv6 because the diversification and mobility support of a mobile communication network has emerged as a core technology. Furthermore, IFOM has not adopted PMIPv6 for a reason of a technical problem in which it is difficult to manage an IP flow unit. Furthermore, IFOM is a client-based mobile IP (MIP) technology in which UE detects its own movement and notifies an agent of such a movement. A home agent (HA) is an agent for managing the mobility of mobile nodes, and has a flow binding table and a binding cache table. In IFOM, unlike in MAPCON, although pieces of UE are connected to a PDN using the same APN, they may be connected to the PDN over different access networks. IFOM is a mobility and offloading unit, and enables a movement in a specific IP traffic flow unit not a PDN. Accordingly, IFOM has flexibility in providing services. For IFOM, an ANDSF server may provide IP flow information on which offloading will be performed, a routing rule between access networks, the time of a day when an offloading method is applied, and access network (validity area) information on which offloading will be performed.

Non-seamless WLAN offloading is a technology for changing the route of specific IP traffic into a WLAN and also completely offloading traffic so that the traffic does not pass through an evolved packet core (EPC). In order to support mobility, anchoring is not performed on a packet data network gateway (PDN GW), and thus offloaded IP traffic is unable to seamlessly move to 3GPP access again. For non-seamless WLAN offloading, an ANDSF server may provide information that is similar to information provided to UE for IFOM.

In various scenarios, 3GPP/WLAN interworking may be performed. In various scenarios, a case where UE connected to 3GPP LTE is able to perform only uplink (UL) transmission to a BS and is difficult to perform downlink (DL) reception from a BS or a case where UE connected to 3GPP LTE is able to perform only DL reception from a BS and is difficult to perform UL transmission to a BS may be taken into consideration. In such a scenario, a method for transmitting control information for the 3GPP LTE system of UE may be problematic.

### SUMMARY OF THE INVENTION

An object of the present invention is to provide a method for transmitting control information in a wireless communication system.

Another object of the present invention is to provide an apparatus for transmitting control information in a wireless communication system.

A method for transmitting control information in a wireless communication system according to an aspect of the present invention for achieving the aforementioned objects may include the steps of transmitting, by UE, first cellular control information to an eNB on a cellular system and transmitting, by the UE, second cellular control information to the eNB through an access point (AP) on a WLAN system, wherein the UE may be capable of communicating with the eNB and the AP, and the first cellular control information and the second cellular control information may be control information for a service for the UE by the eNB.

Meanwhile, the first cellular control information includes measurement report information about a first measurement target eNB and a first measurement target AP which have transmitted radio signals which belong to the radio signals of all of measurement target eNBs and radio signals of all of measurement target APs and which have sizes greater than or equal to a first critical value. The second cellular control information includes measurement report information about a second measurement target eNB and a second measurement target AP which have transmitted radio signals which belong to the radio signals of all of the measurement target eNBs and the radio signals of all of the measurement target APs and which have sizes greater than a second critical value and smaller than the first critical value. The second cellular control information may be transmitted from the UE to the AP on time resources determined based on a measurement report interval set by the eNB.

UE sending control information in a wireless communication system according to another aspect of the present invention for achieving the aforementioned objects may include a radio frequency (RF) unit sending a radio signal and a processor operatively connected to the RF unit, wherein the processor may be implemented to transmit first cellular control information to an eNB on a cellular system and to transmit second cellular control information to an eNB through an access point (AP) on a WLAN system, the processor is implemented to be capable of communication with the eNB and the AP through the RF unit, and the first cellular control information and the second cellular control information may be control information for a service for the UE by the eNB.

Meanwhile, the first cellular control information includes measurement report information about a first measurement target eNB and a first measurement target AP which have transmitted radio signals which belong to the radio signals of all of measurement target eNBs and radio signals of all of measurement target APs and which have sizes greater than or equal to a first critical value. The second cellular control information includes measurement report information about a second measurement target eNB and a second measurement target AP which have transmitted radio signals which belong to the radio signals of all of the measurement target eNBs and the radio signals of all of the measurement target APs and which have sizes greater than a second critical value and smaller than the first critical value. The second cellular control information may be transmitted from the UE to the AP on time resources determined based on a measurement report interval set by the eNB.

A traffic burden on a cellular network can be reduced because cellular control information for the service of UE according to a cellular system is transmitted to a BS through a WLAN system.

### BRIEF DESCRIPTION OF THE DRAWINGS

FIG. 1 is a cellular system.

FIG. 2 shows a wireless local area network (WLAN) system.

FIG. 3 is a conceptual diagram showing the architecture of a 3GPP LTE/Wi-Fi interworking network.

FIG. 4 is a conceptual diagram showing a channel access method based on EDCA in a WLAN.

FIG. 5 is a conceptual diagram showing a backoff procedure of EDCA.

FIG. 6 is a conceptual diagram showing the configuration of a 3GPP LTE and Wi-Fi convergence communication system.

FIG. 7 is a conceptual diagram showing the configuration of a 3GPP LTE and Wi-Fi convergence communication system.

FIG. 8 shows another example of the configuration of a 3GPP LTE and Wi-Fi convergence communication system.

FIG. 9 is a conceptual diagram showing the configuration of a 3GPP LTE and Wi-Fi convergence communication system.

FIG. 10 is a conceptual diagram showing a method for decoupling data in the convergence communication system of a cellular system and a WLAN system according to an embodiment of the present invention.

FIG. 11 is a conceptual diagram showing a method for transmitting, by UE, control information through a WLAN system according to an embodiment of the present invention.

FIG. 12 is a conceptual diagram showing a method for transmitting, by UE, cellular control information through a WLAN system according to an embodiment of the present invention.

FIG. 13 is a conceptual diagram showing a method for transmitting, by UE, cellular control information through a WLAN system according to an embodiment of the present invention.

FIG. 14 is a conceptual diagram showing a method for transmitting, by UE, cellular control information through a WLAN system according to an embodiment of the present invention.

FIG. 15 is a conceptual diagram showing a method for transmitting, by UE, cellular control information through a WLAN system according to an embodiment of the present invention.

FIG. 16 is a conceptual diagram showing a tracking update method through a WLAN system according to an embodiment of the present invention.

FIG. 17 is a conceptual diagram showing a method for transmitting cellular control information through a WLAN system according to an embodiment of the present invention.

FIG. 18 is a conceptual diagram showing a method for transmitting cellular control information through a WLAN system according to an embodiment of the present invention.

FIG. 19 is a block diagram of a wireless communication system in which an embodiment of the present invention is implemented.

### DESCRIPTION OF EXEMPLARY EMBODIMENTS

Technologies described below may be used for various multiple access schemes, including code division multiple access (CDMA), frequency division multiple access (FDMA), time division multiple access (TDMA), orthogonal frequency division multiple access (OFDMA), and single carrier-frequency division multiple access (SC-FDMA). CDMA may be implemented using a radio technology, such as universal terrestrial radio access (UTRA) or CDMA2000. TDMA may be implemented using a radio technology, such as global system for mobile communications (GSM)/general packet radio service (GPRS)/enhanced data rates for GSM evolution (EDGE). OFDMA may be realized using a radio technology, such as IEEE 802.11 (Wi-Fi), IEEE 802.16 (WiMAX), IEEE 802.20, or evolved UTRA (E-UTRA). UTRA is part of a universal mobile telecommunications system (UMTS). 3GPP LTE is part of an evolved UMTS (E-UMTS) using E-UTRA, and adopts OFDMA in downlink and adopts SC-FDMA in uplink. LTE-advanced (LTE-A) is the evolution of LTE.

In order to clarify a description, LTE-A and IEEE 802.11 are chiefly described, but the technical characteristics of the present invention are not limited thereto.

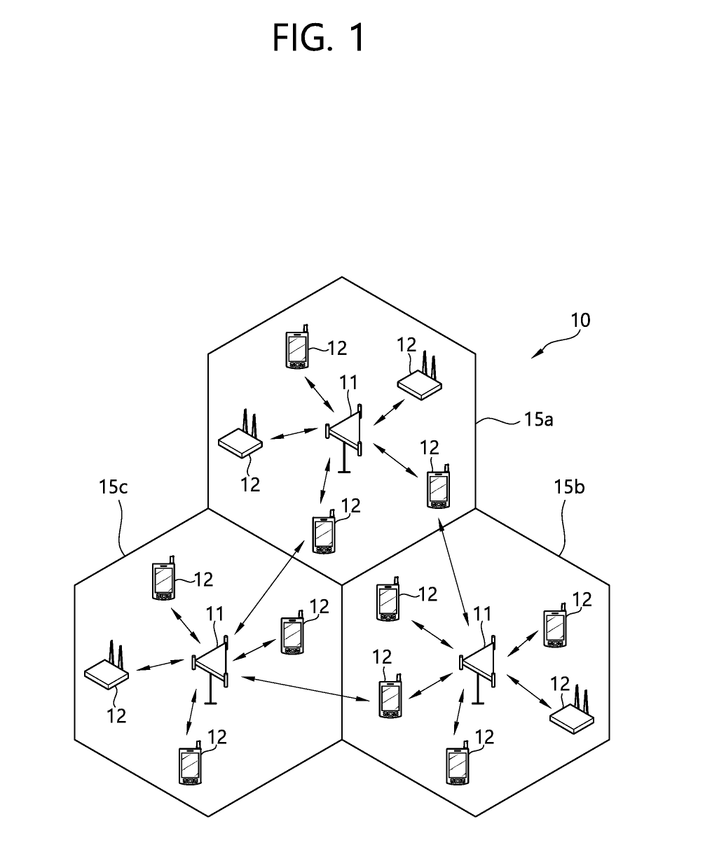

FIG. 1 is a cellular system.

Referring to FIG. 1, the cellular system 10 includes at least one base station (BS) 11. The BS 11 provides a communication service to a specific geographical area (in general, called a cell) 15a, 15b, 15c. The cell may be subdivided into a plurality of regions (called sectors). The cell may also be used as a meaning indicative of frequency resources. User equipment (UE) 12 may be fixed or may have mobility, and may be called a different term, such as a mobile station (US), a mobile terminal (MT), a user terminal (UT), a subscriber station (SS), a wireless device, a personal digital assistant (PDA), a wireless modem, or a handheld device. In general, the BS 11 refers to a fixed point that communicates with the UE 12, and may also be called a different term, such as an evolved-NodeB (eNB), a base transceiver system (BTS), or an access point.

In general, UE belongs to one cell. A cell to which UE belongs is called a serving cell. A BS that provides a communication service to a serving cell is referred to as a serving BS. A cellular system includes another cell that neighbors a serving cell. Another cell that neighbors a serving cell is called a neighbor cell. A BS that provides a communication service to a neighbor cell is referred to as a neighbor BS. A serving cell and a neighbor cell are relatively determined based on UE.

Such a technology may be used in downlink (DL) or uplink (UL). In general, DL means communication from the BS 11 to the UE 12, and UL means communication from the UE 12 to the BS 11. In DL, a transmitter may be part of the BS 11, and a receiver may be part of the UE 12. In UL, a transmitter may be part of the UE 12, and a receiver may be part of the BS 11.

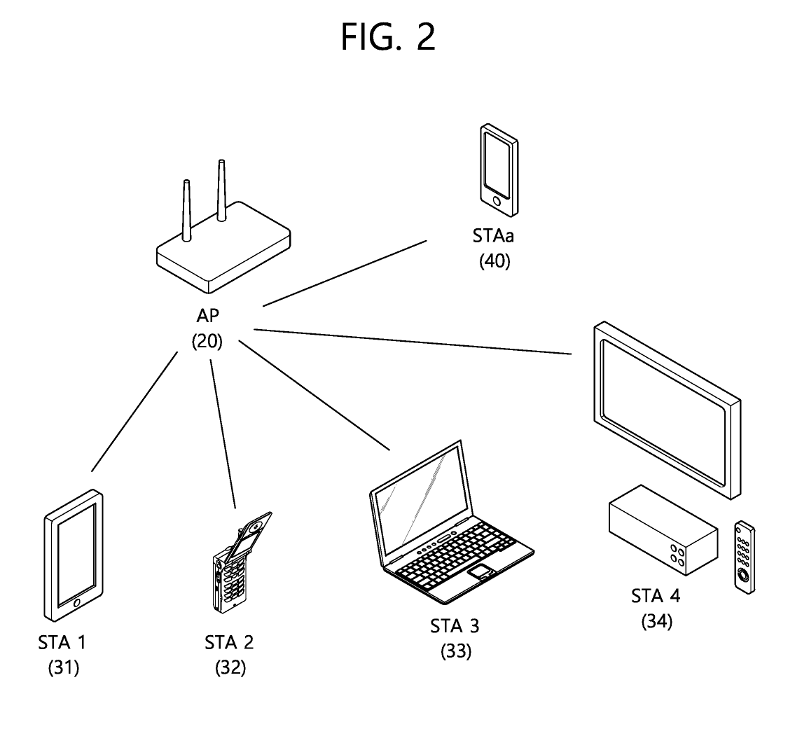

FIG. 2 shows a wireless local area network (WLAN) system.

The WLAN system may be called Wi-Fi. Referring to FIG. 2, the WLAN system includes one access point (AP) 20 and a plurality of stations (STAs) 31, 32, 33, 34, and 40. The AP 20 is connected to the STAs 31, 32, 33, 34, and 40 and may communicate with the STAs. The WLAN system includes one or more basic service sets (BSSs). The BSS is a set of STAs which are successfully synchronized and are capable of communicating with each other. In general, the BSS is not a concept indicative of a specific area, but may also be interpreted as a concept of coverage.

An infrastructure BSS includes one or more non-AP STAs, a distributed system connecting a plurality of APs, and an AP providing the distributed system. In the infrastructure BSS, the AP manages the non-AP STAs of the BSS. Accordingly, the WLAN system shown in FIG. 2 may include an infrastructure BSS. In contrast, an independent BSS (IBSS) is a BSs operating in ad-hoc mode. The IBSS does not have a centralized management entity because it does not include an AP. That is, in the IBSS, non-AP STAs are managed in a distributed manner. In the IBSS, all of STAs may be formed of mobile STAs, and form a self-contained network because access to a distributed system is not permitted.

An STA is a specific functional medium including medium access control (MAC) and a physical layer interface for radio media in accordance with the IEEE 802.11 standards. In a wider sense, the term STA includes both an AP and a non-AP STA.

A non-AP STA is an STA that is not an AP. A non-AP STA may also be referred to as a different name, such as a mobile terminal, a wireless device, a wireless transmit/receive unit (WTRU), user equipment (UE), a mobile station (MS), a mobile subscriber unit, or simply a user. Hereinafter, a non-AP STA is referred to as an STA, for convenience of explanation.

An AP is a functional entity which provides access to a distributed system through a radio medium for an STA associated with the corresponding AP. In an infrastructure BSS including an AP, in principle, communication between STAs is basically performed through the AP. If a direct link has been established, however, the STAs may directly communicate with each other. The AP may also be called a central controller, a base station (BS), a NodeB, a base transceiver system (BTS), or a site controller.

A plurality of infrastructure BSSs may be interconnected through a distributed system. The plurality of interconnected BSSs may be called an extended service set (ESS). APs and/or STAs included in the ESS may communicate with each other. In the same ESS, an STA may move from one BSS to the other BSS while maintaining seamless communication.

Hereinafter, in an embodiment of the present invention, an STA or UE may be construed as an apparatus capable of cellular/WLAN interworking, which is capable of the interworking of a cellular system and a WLAN system.

Cellular/WLAN interworking (or interoperation) is described below. One of the requirements of the 5^{th} generation mobile communication technology includes interworking between heterogeneous wireless communication systems. The 5^{th} generation mobile communication system may introduce a plurality of radio access technologies (RATs) so that access is possible anywhere and at any time and efficient performance can be maintained. The 5^{th} generation mobile communication system may convert and use a plurality of RAT through interworking between heterogeneous wireless communication systems. Peak throughput can be increased and data traffic can be offloaded through interworking between heterogeneous wireless communication systems. Entities of a plurality of RATs forming the 5^{th} generation mobile communication system may exchange data. Accordingly, an optimum communication system can be provided to a user within the 5^{th} generation mobile communication system.

A specific RAT of a plurality of RATs forming the 5^{th} generation mobile communication system may operate as a primary RAT system, and another specific RAT thereof may operate as a secondary RAT system. That is, the primary RAT system functions to chiefly provide a communication system and control information to a user within the 5^{th} generation mobile communication system. The secondary RAT system may be used to assist the primary RAT system and to transmit data. In general, a cellular system having relatively wide coverage may become a primary RAT system. A cellular system may be any one of 3GPP LTE, 3GPP LTE-A, and IEEE 802.16 systems (e.g., WiMax or WiBro). A WLAN system having relatively narrow coverage may become a secondary RAT system. The WLAN system may be Wi-Fi. In particular, a WLAN is a wireless communication system which is used in various types of UE in common, and thus cellular/WLAN interworking is a convergence technology having a high routing rule. The coverage and capacity of a cellular system can be increased through offloading according to cellular/WLAN interworking.

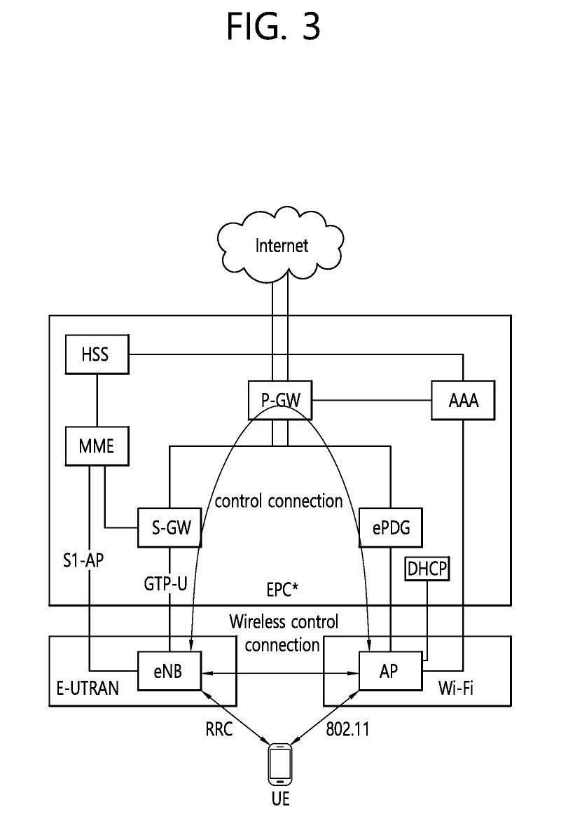

FIG. 3 is a conceptual diagram showing the architecture of a 3GPP LTE/Wi-Fi interworking network.

The interworking of 3GPP LTE and Wi-Fi is a practical model of the interworking of a cellular system and a WLAN system.

Referring to FIG. 3, multi-RAT UE having the ability to be capable of accessing two or more RATs is connected to an eNB within an evolved universal terrestrial radio access network (E-UTRAN) and is also connected to an AP within Wi-Fi. The eNB is connected to a mobility management entity (MME) and a serving gateway (S-GW) within an evolved packet core (EPC) through an S1-AP and a GPRS tunneling protocol user plane (GTP-U), respectively. The AP is connected to an evolved packet data gateway (ePDG) and a dynamic host configuration protocol (DHCP) within the EPC. The S-GW and the ePDG are connected to the Internet and a packet data network gateway (P-GW). A backhaul control connection may be present between the AP and the eNB through a backbone network via the P-GW or the EPC. Alternatively, a radio control connection may be present between the eNB and the AP. In addition, the AP is connected to an authentication, authorization and accounting (AAA) server within the EPC. The AAA server is connected to a P-GW and is also connected to a home subscriber server (HSS) within the EPC. The HSS is connected to the MME.

The interworking of 3GPP LTE and Wi-Fi may be performed based on multi-RAT UE using the architecture illustrated in FIG. 3. In order for the multi-RAT UE to access a specific RAT, the multi-RAT UE may request connection setup from the specific RAT and may transmit and receive data through the corresponding RAT. This is a multi-RAT access technology according to core network-based UE. Furthermore, information may be exchanged between a plurality of RATs using an access network discovery and selection function (ANDSF) server.

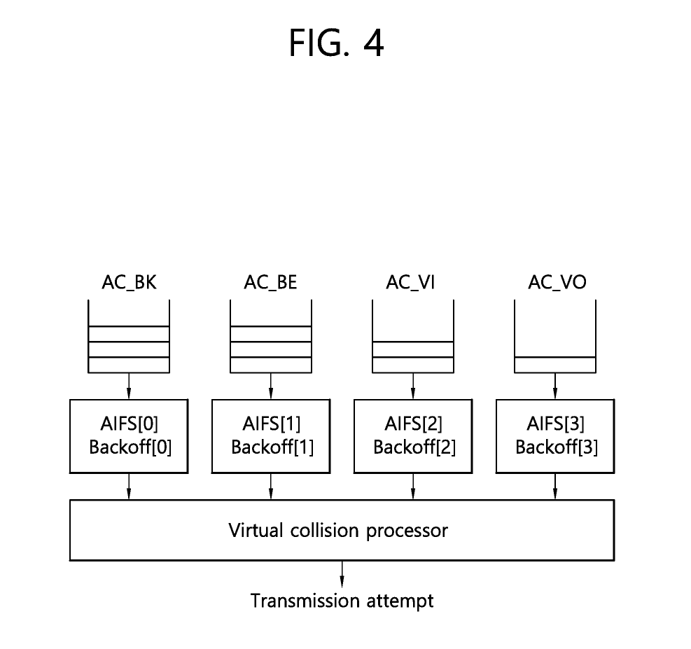

FIG. 4 is a conceptual diagram showing a channel access method based on EDCA in a WLAN.

In the WLAN, an STA which performs channel access based on enhanced distributed channel access (EDCA) may define a plurality of user routing rules for traffic data and perform channel access. For the transmission of quality of service (QoS) data frames based on a routing rule, EDCA defines four access categories (ACs) (AC_BK (background), AC_BE (best effort), AC_VI (video), and AC_VO (voice)). In EDCA, traffic data which has different user routing rules and reach a medium access control (MAC) layer may be mapped based on the ACs as in <Table 1> below.

Table 1 is an exemplary table showing mapping between user routing rules and the ACs.

TABLE 1

| ROUTING | USER | ACCESS |
|---|---|---|
| RULE | ROUTING RULES | CATEGORY (AC) |
| Low | 1 | AC_BK |
| | 2 | AC_BK |
| | 0 | AC_BE |
| | 3 | AC_BE |
| | 4 | AC_VI |
| | 5 | AC_VI |
| | 6 | AC_VO |
| High | 7 | AC_VO |

A transmission queue and an AC parameter may be defined with respect to each AC. A difference between the transmission routing rules of the ACs may be implemented based on differently set AC parameter values. In EDCA, in a backoff procedure for transmitting a frame belonging to AC, an arbitration interframe space (AIFS)[AC], CWmin[AC], and CWmax[AC] may be used instead of a DCF interframe space (DIFS), CWmin, and CWmax that are parameters for a backoff procedure based on a distributed coordination function (DCF). An EDCA parameter used in the backoff procedure for each AC may be carried on a beacon frame and delivered from an AP to each STA. The smaller the AIFS[AC] and CWmin[AC] value, the higher the routing rule. Accordingly, more bands can be used in a given traffic environment because channel access delay is shortened.

Specifically, an AP may transmit an EDCA parameter set element, including information about a parameter for channel access based on EDCA, to an STA. The EDCA parameter set element may include information about the channel access parameters AIFS [AC], CWmin[AC], and CWmax[AC] for the respective ACs.

If a collision is generated between STAs while an STA transmits a frame, the backoff procedure of EDCA for generating a new backoff count is similar to an existing DCF backoff procedure. A backoff procedure different for each AC may be performed based on a different EDCA parameter. The EDCA parameter becomes important means which is used to differentiate channel access of various types of user routing rule traffic. Proper setting of an EDCA parameter value that defines a different channel access parameter for each AC can optimize network performance and can also increase a transmission effect according to a routing rule of traffic. Accordingly, an AP needs to perform an overall management and adjustment function on EDCA parameters in order to guarantee fair medium access for all of STAs which have participated in a network.

Referring to FIG. 4, four transmission queues for the respective ACs, which are defined in 802.11e MAC, may play the role of respective EDCA contention entities for radio medium access within one STA. One AC may have its own AIFS value and maintain an independent backoff count. If one or more ACs that have finished backoff at the same time are present, a collision between the ACs may be adjusted by a virtual collision handler. A frame within an AC having the highest routing rule is first transmitted, and the remaining ACs update their backoff counts by increasing their contention window values.

The start of a transmission opportunity (TXOP) is generated when a channel is accessed in accordance with an EDCA rule. If an EDCA TXOP is obtained when two or more frames are accumulated on one AC, EDCA MAC may attempt the transmission of several frames. If an STA has already transmitted one frame and is able to transmit a next frame within the same AC and to receive ACK corresponding to the transmission within the remaining TXOP time, the STA attempts the transmission of the next frame after an SIFS time interval. A TXOP limit value may be delivered from an AP to an STA. If the size of a data frame to be transmitted exceeds the TXOP limit value, the STA may fragment the data frame into several small frames and transmit them within the range that does not exceed the TXOP limit value.

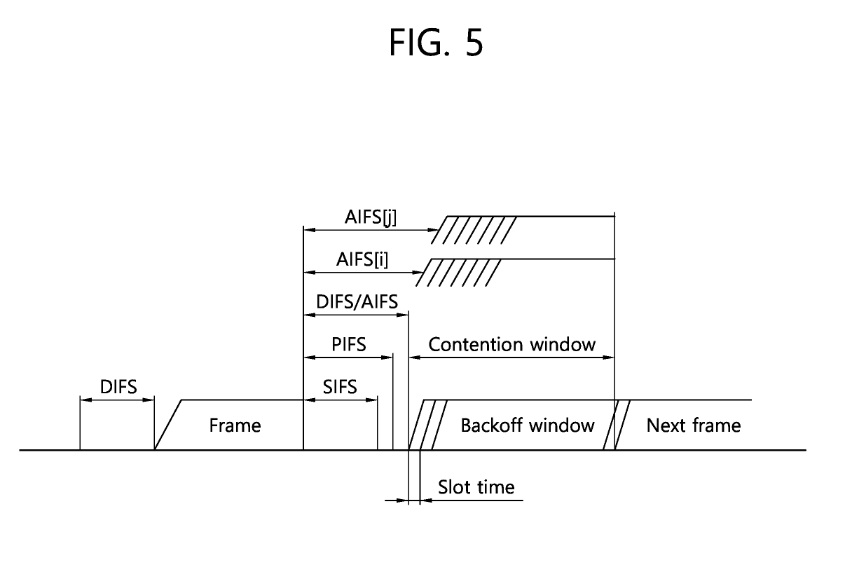

FIG. 5 is a conceptual diagram showing a backoff procedure of EDCA.

Referring to FIG. 5, each piece of traffic data transmitted by an STA has a routing rule, and a backoff procedure may be performed on the traffic data based on a contending EDCA method. For example, a routing rule assigned to each piece of traffic may be divided into 8, for example. As described above, an output queue is different according to a routing rule within one STA, and each output queue operates in accordance with the EDCA rule. Each output queue may transmit traffic data using a different arbitration interframe space (AIFS) in accordance with a routing rule instead of the existing DCF interframe space (DIFS). Furthermore, if an STA has to transmit traffic having different routing rules at the same time, the STA transmits traffic having a higher routing rule in order to prevent a collision within the STA.

A backoff procedure is generated in the following situation. If UE transmits a frame, a transmission collision is generated and thus a backoff procedure is used when retransmission is necessary. In order start the backoff, the UE sets a specific backoff time in a backoff timer using Equation 1 below.

T_{b}[i]=Random(i)×SlotTime [Equation 1]

In this case, Random(i) is a function that generates a specific integer between 0 and CW[i] using a uniform distribution. CW[i] is a contention window between a minimum contention window CWmin[i] and a maximum contention window CWmax[i], and i designates a traffic routing rule. Whenever a collision is generated, a new contention window CW_{new}[i] is calculated in accordance with Equation 2 below using a pervious window CW_{old}[i].

CW_{new}[i]=((CW_{old}[i]+1)×PF)−1 [Equation 2]

In this case, PF is calculated according to a procedure defined in the IEEE 802.11e standard. CWmin[i], AIFS[i], and PF values may be transmitted by an AP using a QoS parameter set element, that is, a management frame.

Hereinafter, in an embodiment of the present invention, UE may be a device capable of supporting both a WLAN system and a cellular system. That is, UE may be construed as UE supporting a cellular system or an STA supporting a WLAN system.

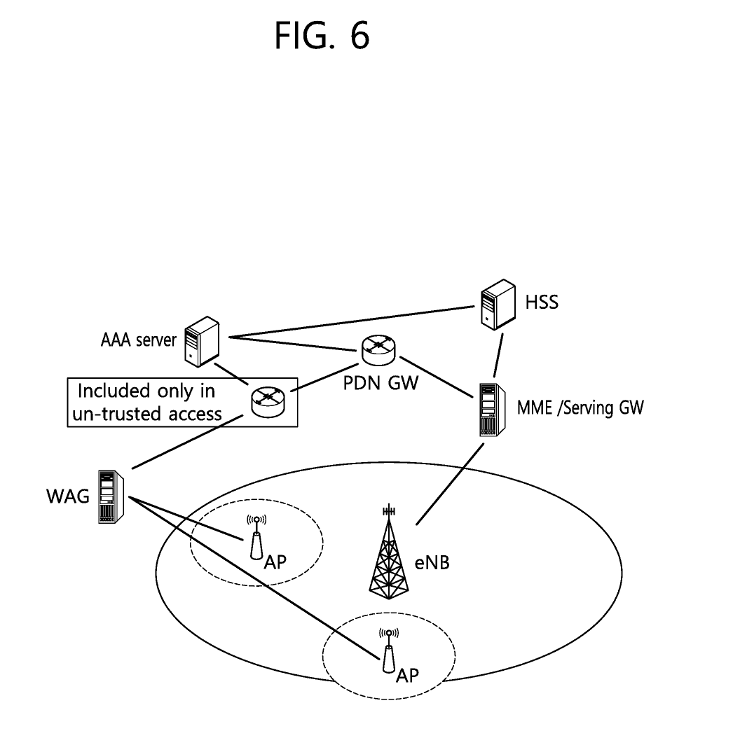

FIG. 6 is a conceptual diagram showing the configuration of a 3GPP LTE and Wi-Fi convergence communication system.

Referring to FIG. 6, an eNB is connected to an MME/S-GW, and the MME/S-GW is connected to a P-GW and an HSS. An AP is connected to a Wi-Fi access gateway (WAG), and the WAG is connected to the P-GW and an AAA server. An ePDG may be included in only un-trusted access. The AAA server is connected to the HSS.

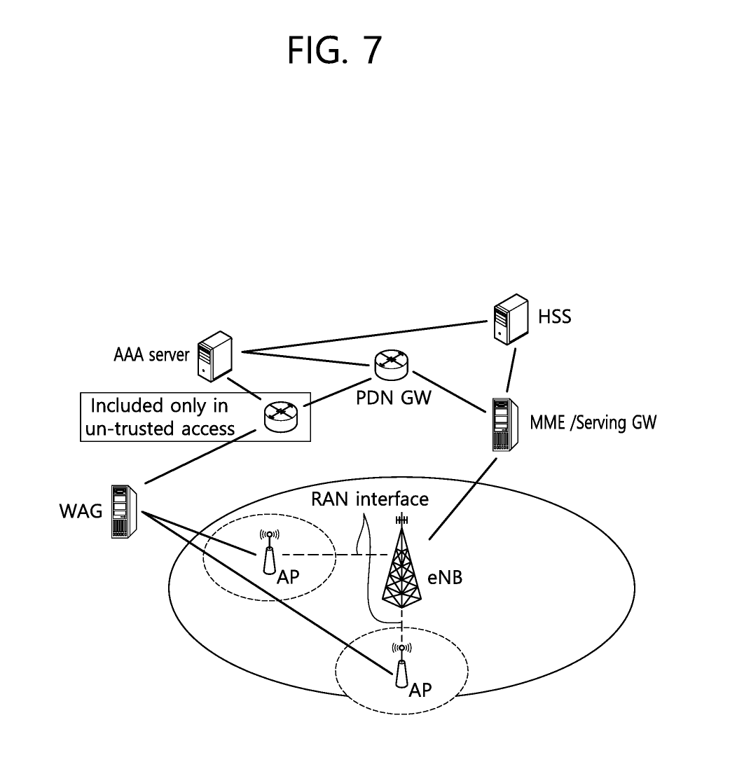

FIG. 7 is a conceptual diagram showing the configuration of a 3GPP LTE and Wi-Fi convergence communication system.

Referring to FIG. 7, the configuration of the network disclosed in FIG. 5 is the same as that of the network disclosed in FIG. 6, and additionally includes a radio access network (RAN) interface between an eNB and an AP.

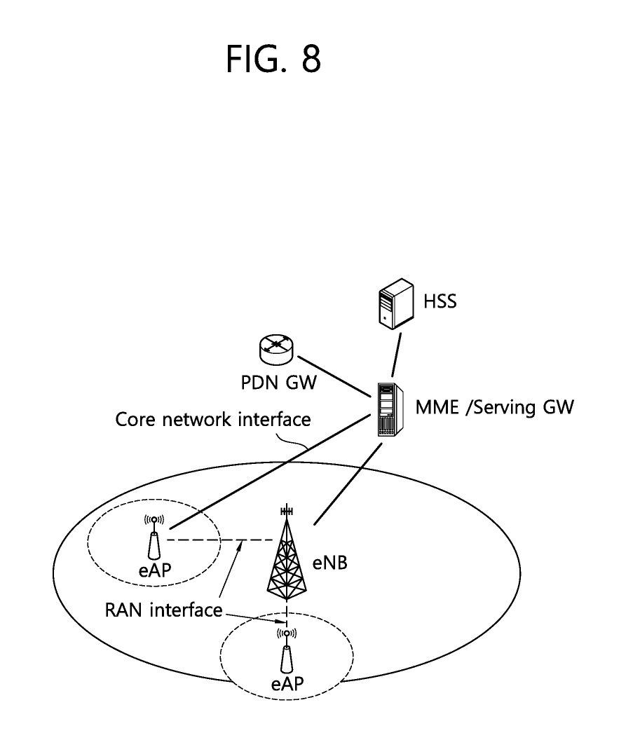

FIG. 8 shows another example of the configuration of a 3GPP LTE and Wi-Fi convergence communication system.

Referring to FIG. 8, an eNB and an eAP are connected to an MME/S-GW through a core network interface. An RAN interface is present between the eNB and the eAP. The MME/S-GW is connected to a P-GW and an HSS.

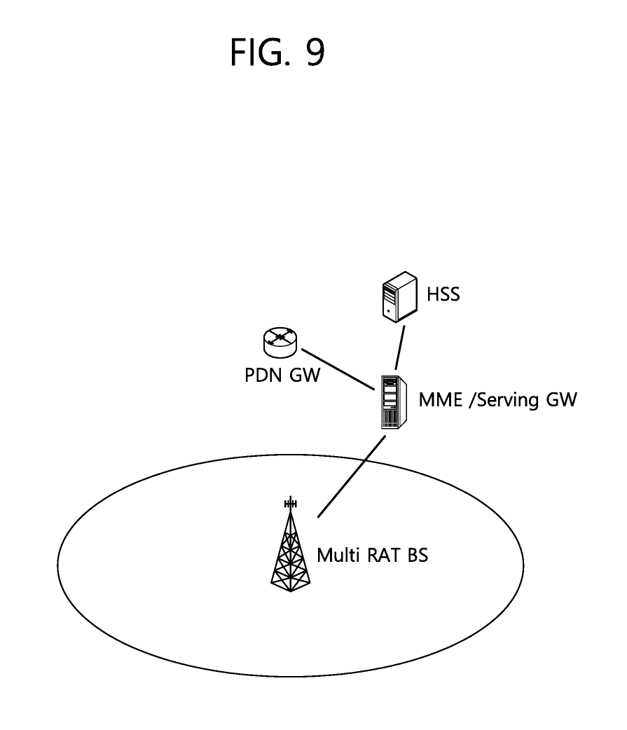

FIG. 9 is a conceptual diagram showing the configuration of a 3GPP LTE and Wi-Fi convergence communication system.

Referring to FIG. 9, a multi-RAT BS supporting a plurality of RAT is connected to an MME/S-GW. The S-GW is connected to a P-GW and an HSS.

In such an existing convergence communication system of a cellular system (e.g., 3GPP LTE) and a WLAN system (Wi-Fi), various problems may occur.

For example, an imbalance situation between the amount of UL traffic and the amount of DL traffic may be generated. If UE is placed close to the AP of an eNB and the AP, it may be effective that the UE transmits UL data to be transmitted to the eNB through the AP.

Or, a situation in which a burden of an UL channel on a WLAN is high may be generated. In a WLAN system, an AP and UE may obtain an opportunity for transmitting a frame through a medium by performing contention-based channel access in the same manner. Accordingly, if a plurality of pieces of UE and an AP contend with each other for channel access on a WLAN, it may be difficult for the AP to obtain an opportunity for DL transmission to specific UE.

Or, a situation in which transmission power of UE is limited may be generated. The simultaneous transmission of UL data through a cellular system and a WLAN system may be difficult because maximum transmission power of UE is limited due to the limits of an electromagnetic field (EMF).

Or, a case where UE is placed at a cell edge may be generated. DL reception performance of specific UE may be deteriorated due to interference from a neighbor cell. Furthermore, UL transmission performance of UE may be deteriorated due to UL interference that is generated between cells when UE placed at a cell edge performs UL transmission.

Hereinafter, in an embodiment of the present invention, the decoupling of control data and traffic data for solving the existing problems in the convergence communication system of a cellular system (e.g., 3GPP LTE) and a WLAN system (Wi-Fi or WLAN) is disclosed. That is, control data and traffic data may be transmitted through different communication systems (a cellular system or a WLAN system).

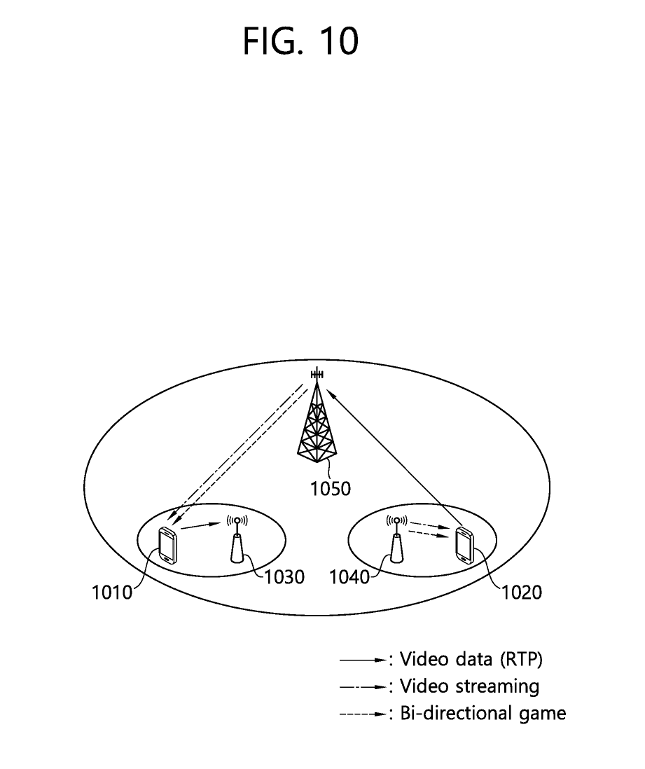

FIG. 10 is a conceptual diagram showing a method for decoupling data in the convergence communication system of a cellular system and a WLAN system according to an embodiment of the present invention.

Referring to FIG. 10, the UL transmission of UE and DL transmission for the UE may be performed through different radio access technologies (RATs).

For example, first UE may transmit voice data to be transmitted to an eNB to the eNB through an AP in UL. Furthermore, the first UE may directly receive DL data for video streaming and bidirectional game from the eNB.

Second UE may directly transmit voice data to the eNB in UL. Furthermore, the second UE may receive DL data for video streaming and bidirectional game from the eNB through the AP.

That is, the UL data of each of a plurality of pieces of UE may be directly transmitted to an eNB or may be transmitted to the eNB through an AP. Furthermore, DL data for each of the plurality of pieces of UE may be directly transmitted by the eNB or may be transmitted by the eNB through the AP. If decoupling for UL transmission is possible, UE may perform UL transmission through an RAT selected from a plurality of RATs by taking into consideration the state of radio resources (or a radio channel state). Likewise, if decoupling for DL transmission is possible, an eNB may perform DL transmission through an RAT selected from a plurality of RATs by taking into consideration the state of radio resources (or a radio channel state).

A potential gain of decoupling (or RAT division duplex) may be as follows.

In a DL/UL imbalance environment, UL performance of UE may be improved. In a communication environment including many pieces of UE, an opportunity for transmitting DL data over a WLAN may be increased. Furthermore, if UE and an AP are adjacent, the UE may transmit UL data through the AP, thereby being capable of minimizing power consumed by the UE. If the amount of DL data to be transmitted in a cellular network is much, the offloading of the DL data in which the DL data is transmitted over a WLAN may be performed.

The control data and traffic data of specific UE may also be transmitted based on decoupling. For example, UE may transmit the traffic data of the UL data of the UE through a cellular system, and may transmit the control data of the UL data of the UE through a WLAN system.

A detailed method for transmitting traffic data and control data through different RATs of UE is disclosed hereinafter.

A WLAN system may be less sensitive to a data traffic burden than a cellular system. UE may transmit cellular control information (control information for the operation of a cellular system) to be transmitted to an eNB (a BS or an interworking entity (IWE)) of a cellular system to the eNB through an AP of a WLAN system. Hereinafter, in an embodiment of the present invention, it may be assumed that an eNB is aware of information about an AP associated with UE (or may be associated with the UE).

UE according to an embodiment of the present invention may transmit cellular control information that belong to cellular control information and that is not sensitive to delay or that is required for control of a WLAN system by a cellular system to an eNB or an AP through the WLAN system not a cellular system. If UE is idle with a cellular system, the transmission of the cellular control information of UE through a WLAN system, which is performed without a radio resource control (RRC) connection, may be relatively faster than that of cellular control information through a cellular system. Transmission power of the UE may be reduced.

A detailed method for transmitting, by UE, cellular control information through a WLAN system is described below. It is assumed that the UE is capable of supporting both a cellular system and a WLAN system.

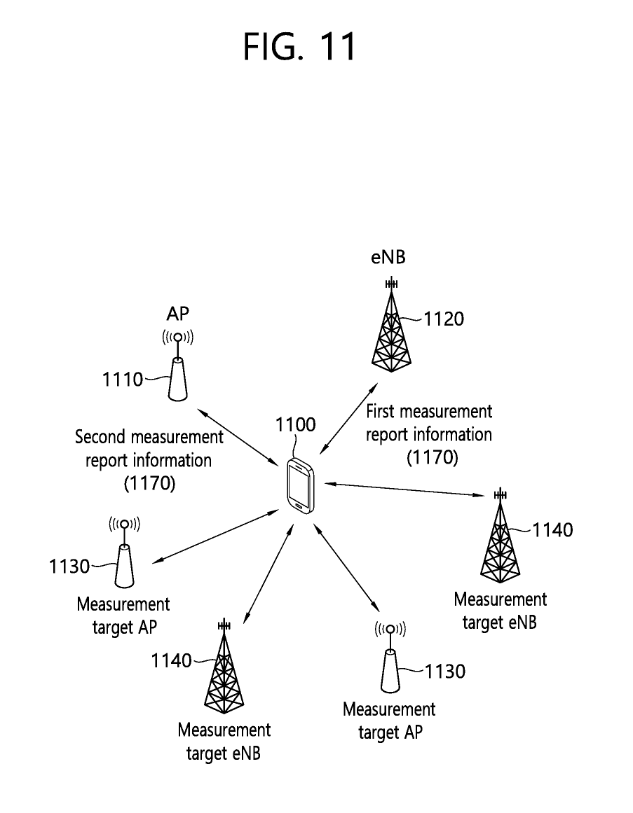

FIG. 11 is a conceptual diagram showing a method for transmitting, by UE, control information through a WLAN system according to an embodiment of the present invention.

FIG. 11 discloses a method for transmitting, by UE, control information through a WLAN system based on classification for measurement results.

An eNB may support the transmission of the cellular control information of UE through a WLAN system based on information about an AP placed within coverage of the eNB (or an AP within a cell), the measurement results of a signal transmitted by the AP, information about an adjacent BS of the eNB, and the measurement results of a signal transmitted by the adjacent BS. The UE may classify the measurement results (or classify a class for the measurement results) and transmit information about the measurement results to the eNB or the AP.

Referring to FIG. 11, an eNB 1120 may transmit information (or measurement configuration information) for the measurement configuration of a signal transmitted by a measurement target eNB (an eNB and/or an eNB adjacent to the eNB) 1140 (hereinafter referred to as a “measurement target eNB signal”) and/or the measurement configuration of a signal transmitted by a measurement target AP 1130 (an AP associated with an STA and/or an AP adjacent to an AP associated with UE) (hereinafter referred to as a “measurement target AP signal”) to UE 1100. Hereinafter, an AP 1110 associated with the UE 1100 and the eNB 1120 that provides a service to the UE 1100 are excluded from the measurement target AP and the measurement target eNB, for convenience of description.

The measurement configuration information may include information about a detailed configuration for the measurement of the signal transmitted by the measurement target eNB 1140 or the measurement target AP 1130. The UE 1100 may perform measurement on the radio signal, transmitted by the measurement target eNB 1140 or the measurement target AP 1130, based on the measurement configuration information.

Furthermore, the eNB 1120 may transmit configuration information (measurement report configuration information) about measurement results that belong to the measurement results of the measurement target AP signal and/or the measurement results of the measurement target eNB signal and that will be reported to the eNB 1120 and/or the AP 1110 associated with the UE to the UE 1100.

For example, the eNB 1120 may perform a configuration so that measurement results (or measurement results satisfying a first configuration condition) that belong to the measurement results of the measurement target AP signal and/or the measurement results of the measurement target eNB signal measured by the UE 1100 and that exceed a first critical value (or a value equal to or greater than the first critical value) are transmitted to the eNB 1120 based on the measurement report configuration information. Furthermore, the eNB 1120 may perform a configuration so that measurement results (or measurement results satisfying a second configuration condition) that belong to the measurement results of the measurement target AP signal and/or the measurement results of the measurement target eNB signal measured by the UE 1100 and that are greater than a second critical value and smaller than the first critical value are transmitted to the AP 1110 associated with the UE 1100 based on the measurement report configuration information.

Furthermore, the eNB 1120 may configure a measurement report interval to the AP 1110 associated with the UE 1100 for the UE 1100. The measurement report interval is information about a time period for a measurement report toward the AP 1110 associated with the UE 1100, and may be a specific value or window value. If the measurement report interval is a window value, one of optional times included in a corresponding window may be used as the measurement report interval. The eNB 1120 may transmit information about the measurement report interval and information about the number of data bits for the measurement report of the UE 1100 (or duration for the measurement report of the UE) to the AP 1110.

Furthermore, if the measurement report information transmitted from the UE 1100 to the AP 1110 is forwarded (forwarded) from the AP 1110, the eNB 1120 may update information about an eNB adjacent to the eNB 1120 (or information about the measurement target eNB) or an AP adjacent to the AP 1110 (or the measurement target AP). The measurement report information may include identification information about the measurement target AP 1130 and the measurement target eNB 1140 measured by the UE 1100.

Specifically, the UE 1100 may receive the measurement report configuration information from the eNB, and may transmit the measurement report information, generated based on the measurement report configuration information, to the eNB 1120 or the AP 1110 associated with the UE 1100. For example, the UE 1100 may transmit information about the measurement target AP 1130 satisfying the first configuration condition (or a measurement event), information about the measurement target eNB 1140 satisfying the first configuration condition, measurement result information (about the measurement target AP 1130 or the measurement target eNB 1140 satisfying the first configuration condition), and the identification information of the UE 1100 to the eNB 1120 as first measurement report information based on the measurement report configuration information. The information about the measurement target AP 1130 may include the service set identifier (SSID), basic service set identifier (BSSID), homogenous extended service set identifier (HESSID), channel number, operating class, etc. of the measurement target AP 1130. Alternatively, the information about the measurement target eNB 1140 may include the cell identifier (an Internet protocol (IP), an E-UTRAN cell global identifier (ECGI), a primary cell identifier (PCID), etc.) of the measurement target eNB 1140. The identification information of the UE 1100 may be the Internet protocol (IP) or cell-radio network temporary identifier (C-RNTI) of the UE 1100.

Furthermore, the UE 1100 may transmit information about the measurement target AP 1130 satisfying the second configuration condition (or not satisfying a measurement event), information about the measurement target eNB 1140 satisfying the second configuration condition, measurement result information (about the measurement target AP 1130 or the measurement target eNB 1140 satisfying the second configuration condition, and the identification information of the UE 1100 to the AP 1110 associated with the UE 1100 as second measurement report information based on the measurement report configuration information. The UE 1100 may transmit the measurement report information to the AP 1110 based on the measurement report interval set by the eNB 1120. The eNB 1120 may set and transmit the measurement report interval of the UE 1100 based on information about an accurate channel access parameter or a specific window (e.g., information about the size of a contention window (CW)) for channel access to a WLAN. The UE 1100 may perform channel access based on information about an accurate channel access parameter or a specific window set by the eNB 1120, and may transmit the measurement report information to the AP 1110. Furthermore, the UE 1100 may instruct the measurement report information to be forwarded to the eNB 1120 of the AP 1110 through a cellular forwarding indicator when transmitting the measurement report information to the AP 1110 for the forwarding of the measurement report information from the AP 1110 to the eNB 1120. Data whose transmission to a cellular system has been instructed based on the cellular forwarding indicator may be transmitted to the eNB 1120 through the AP 1110.

It has been assumed that the UE 1100 determines whether the same configuration condition for the measurement target eNB 1140 and the measurement target AP 1130 is satisfied based on the measurement report configuration information, for convenience of description. However, different configuration conditions may be assigned to the measurement target eNB 1140 and the measurement target AP 1130, and the UE 1100 may determine whether the different configuration conditions for the measurement target eNB 1140 and the measurement target AP 1130, respectively, are satisfied and may transmit measurement report information to the eNB 1120 or the AP 1110.

The AP 1110 associated with the UE 1100 may forward information (e.g., measurement report information indicated based on the cellular forwarding indicator) that belongs to the measurement report information received from the UE 1100 and that has been instructed to be forwarded to the eNB 1120 to the eNB 1120. The AP 1110 associated with the UE 1100 may forward the measurement report information, received from the UE 1100, to the eNB 1120 in various manners. For example, the AP 1110 associated with the UE 1100 may forward the measurement report information, received from the UE 1100, to the eNB 1120 through an ePDG, a P-GW, and an S-GW. Alternatively, if the AP 1110 associated with the UE 1100 and the eNB 1120 are connected based on a radio access network (RAN) interface, the AP 1110 associated with the UE 1100 may forward the measurement report information to the eNB 1120 through an RAN interface.

That is, a method for transmitting control information in a wireless communication system may include the steps of transmitting, by UE, first cellular control information to an eNB on a cellular system and transmitting, by the UE, second cellular control information to the eNB through an AP on a WLAN system. The UE may communicate with the eNB and the AP, and the first cellular control information and the second cellular control information may be information for a service for the UE by the eNB. The first cellular control information may include measurement report information about a first measurement target eNB and a first measurement target AP which have transmitted radio signals that belong to the radio signals of all of measurement target eNBs and the radio signals of all of measurement target APs and that have a value greater than a first critical value. The second cellular control information may include measurement report information about a second measurement target eNB and a second measurement target AP which have transmitted radio signals that belong to the radio signals of all of the measurement target eNBs and the radio signals of all of the measurement target APs and that have a value greater than a second critical value and smaller than the first critical value. The second cellular control information may be transmitted from the UE to the AP on time resources determined based on a measurement report interval set by the eNB.

Furthermore, UE may classify the measurement results of the discovery signal of device to device (D2D) UE, and may transmit the classified measurement results to an eNB or an AP associated with the UE. The UE may perform measurement on a signal transmitted by adjacent D2D UE (a D2D UE signal). The UE may receive measurement report configuration information for the D2D UE from the eNB, and may transmit measurement report information about the D2D UE, generated based on the measurement report configuration information for the D2D UE, to the eNB or the AP associated with the UE.

For example, UE may transmit information about D2D UE satisfying a third configuration condition (or a measurement event), measurement result information (about the D2D UE satisfying the third configuration condition), and the identification information of the UE to an eNB as measurement report information based on measurement report configuration information for the D2D UE.

Furthermore, UE may transmit information about D2D UE satisfying a fourth configuration condition (or not satisfying a measurement event), measurement result information (about the D2D UE satisfying the fourth configuration condition), and the identification information of the UE to an AP associated with the UE as measurement report information based on measurement report configuration information for the D2D UE.

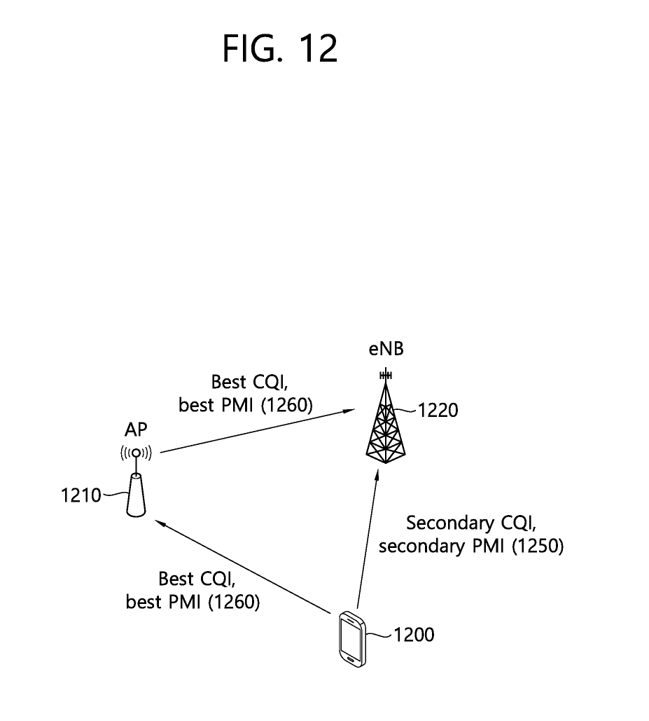

FIG. 12 is a conceptual diagram showing a method for transmitting, by UE, cellular control information through a WLAN system according to an embodiment of the present invention.

FIG. 12 discloses a method for transmitting some of cellular control information through a WLAN system. In particular, there is disclosed a method for classifying a pre-coding matrix indicator (PMI) and a channel quality indicator (CQI), that is, the channel state information of pieces of information transmitted through a physical uplink control channel (PUCCH), and transmitting the classified PMI and CQI.

Delay for selecting the best CQI, PMI in a cellular system may be generated. Accordingly, an eNB may need to rapidly receive a CQI and a PMI from UE through an AP of a WLAN system. If the eNB is able to rapidly receive the channel state information CQI, PMI through the WLAN system, channel state information CQI, PMI into which a channel state is not incorporated due to a change of the channel state can be reduced. That is, a channel aging effect can be reduced.

For example, PMI bits may be increased in massive multiple input multiple output (MIMO). If the PMI bits increase, system overhead may be great in transmitting the PMI bits through a cellular system. Accordingly, the transmission of some control information (e.g., some of all of the PMI bits) through a WLAN system may increase communication efficiency. However, a specific time when data is transmitted is not guaranteed because UE and an AP associated with the UE perform contention-based channel access in the WLAN system. Accordingly, when the UE transmits channel state information (a CQI, a PMI, etc.) through the WLAN system, the UE may additionally transmit measurement time information for providing notification of whether the channel state information is channel state information generated based on a reference signal (e.g., channel state information (CSI)-reference signal (RS)) for channel state measurement, which has been received at which point of time. For example, the measurement time information may be information about a subframe index or a system frame number. Furthermore, when transmitting the channel state information, the UE may additionally transmit the indicator information (a UE ID (an IP, a C-RNTI)) of the UE to the eNB.

Hereinafter, the detailed transmission of channel state information by UE through a WLAN system is disclosed.

Referring to FIG. 12, UE 1200 may transmit pieces of secondary CQI and PMI information 1260 to an eNB 1220 through a WLAN system (or an AP (1210)) in addition to optimum channel state information (e.g., the best (or primary) CQI and optimum (best or primary) PMI) 1250. In an existing cellular system, UE has transmitted the best CQI and PMI to an eNB. If a plurality of pieces of UE report the same CQI and PMI, however, an eNB is unable to allocate the same radio resources to all of a plurality of pieces of UE based on the reported same CQI and PMI. Accordingly, the eNB needs to allocate radio resources to the UE based on a secondary CQI and PMI although the reported CQI and PMI are not the best CQI and PMI.

That is, in accordance with an embodiment of the present invention, the UE 1200 transmits the secondary channel state information 1260 to the eNB 1220 through the WLAN system. The eNB 1220 may allocate radio resources for the UE 1200 by taking into consideration the secondary channel state information 1260, if necessary.

A method for transmitting control information in a wireless communication system may include the steps of transmitting, by UE, first cellular control information to an eNB on a cellular system and transmitting, by the UE, second cellular control information to the eNB through an AP on a WLAN system. The UE may communicate with the eNB and the AP. The first cellular control information and the second cellular control information may be information for a service for the UE by the eNB. In this case, the first cellular control information may include the best CQI and best PMI determined based on a radio signal transmitted by the eNB. The second cellular control information may include a secondary CQI and secondary PMI determined based on a radio signal transmitted by the eNB. The secondary CQI may be a CQI recommended by the UE after the best CQI, and the secondary PMI may be a PMI recommended by the UE after the best PMI. Furthermore, the first cellular control information may include subframe index information indicative of a subframe in which a reference signal for determining the best CQI and the best PMI has been transmitted. The second cellular control information may include subframe index information indicative of a subframe in which a reference signal for determining the secondary CQI and the secondary PMI has been transmitted.

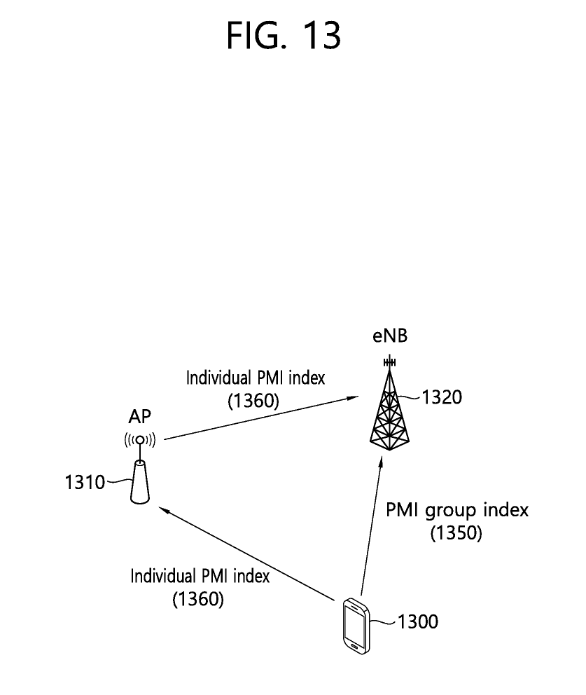

FIG. 13 is a conceptual diagram showing a method for transmitting, by UE, cellular control information through a WLAN system according to an embodiment of the present invention.

FIG. 13 discloses a method for transmitting some of cellular control information through a WLAN system. In particular, there is disclosed a method for transmitting information about a PMI group index 1350 and information about an individual PMI index 1360, which belong to PUCCH information, through a cellular system or a WLAN system.

A codebook index may be divided into the PMI group index 1350 indicative of a PMI group of all of PMIs and the individual PMI index 1360 indicative of an individual PMI within the PMI group. For example, one PMI group may be determined by grouping beams that geographically neighbor each other, and the PMI group index 1350 of the PMI group may be defined. Furthermore, the individual PMI index 1360 indicative of each of the plurality of beams included in the one PMI group may be defined. In this case, the UE 1300 may transmit information, corresponding to the PMI group index 1350, to an eNB 1320 through a cellular system, and may transmit information, corresponding to the individual PMI index 1360, to the eNB 1320 through a WLAN system (or an AP 1310). In contrast, the UE 1300 may transmit the information, corresponding to the PMI group index 1350, to the eNB 1320 through a WLAN system, and may transmit the information, corresponding to the individual PMI index 1360, to the eNB 1320 through a cellular system.

Matching between the PMI group index 1350 and the individual PMI index 1360 may be performed based on a matching indicator assigned to the PMI group index and each individual PMI index. For example, a matching indicator ‘A’ may be assigned to the information about the PMI group index 1350 transmitted through the cellular system, and a matching indicator ‘A’ may be assigned to the information about the individual PMI index 1360 transmitted through the WLAN system. The eNB 1320 may combine the PMI group index 1350 and the individual PMI index 1360 based on the matching indicators and finally receive information about the PMI from the UE 1300.

A method for transmitting control information in a wireless communication system may include the steps of transmitting, by UE, first cellular control information to an eNB on a cellular system and transmitting, by the UE, second cellular control information to the eNB through an AP on a WLAN system. The UE may communicate with the eNB and the AP. The first cellular control information and the second cellular control information may be information for a service for the UE by the eNB. In this case, the first cellular control information may include subframe index information indicative of a subframe in which a PMI group index determined based on a radio signal transmitted by the eNB and a reference signal for determining a PMI group index have been transmitted. The second cellular control information may include subframe index information indicative of a subframe in which an individual PMI index determined based on a radio signal transmitted by the eNB and a reference signal for determining an individual PMI index have been transmitted.

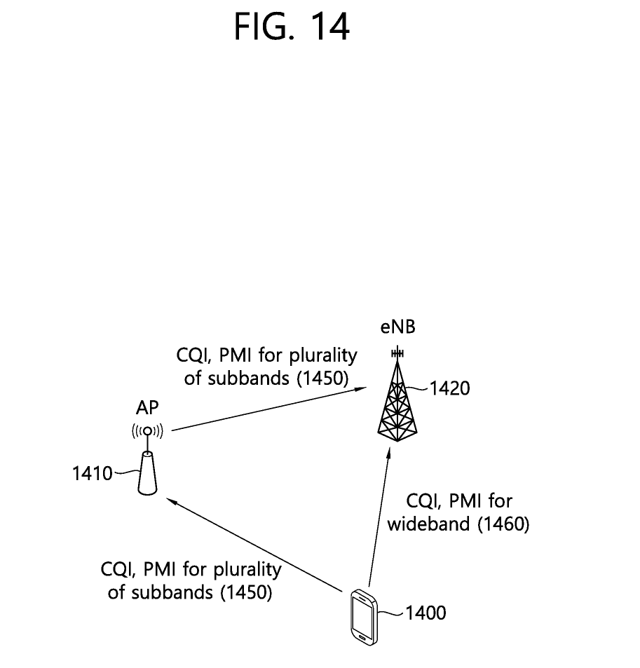

FIG. 14 is a conceptual diagram showing a method for transmitting, by UE, cellular control information through a WLAN system according to an embodiment of the present invention.

FIG. 14 discloses a method for transmitting some of cellular control information through a WLAN system. In particular, channel state information CQI and PMI about a broadband (or a wideband) and channel state information about a lower band (or subband) may be classified, and the channel state information about the wideband and the channel state information about the subband may be classified and transmitted through a cellular system and a WLAN system. A plurality of the subbands may be included in the wideband.

Referring to FIG. 14, UE 1400 may transmit channel state information 1460 about a wideband through a cellular system, and may transmit channel state information 1450 about a plurality of subbands through a WLAN system.

The UE 1400 may transmit information about the CQI and PMI of each of the plurality of subbands at intervals of 1-4 subframe unit in order to report the channel state information about the subbands. Furthermore, the report of the channel state information about the wideband by the UE 1400 may be performed in a period longer than a period for the report of the information about the CQI and PMI of each of the subbands.

If the report period of the information about the CQI and PMI of each of the plurality of subbands is long, it may be more efficient to report the channel state information about the plurality of subbands at once through a WLAN system (or an AP 1410) than to sequentially report the channel state information about the plurality of subbands to the eNB 1420 through a cellular system. The UE 1400 may transmit an optimum subband index (or the best subband index) indicative of the best subband of the plurality of subbands to the eNB 1420 through a WLAN system.

If massive MIMO is introduced as described above, the number of PMI bits may be significantly increased. Accordingly, a report on periodic channel state information (CSI) may increase system overhead compared to a case where the massive MIMO is introduced. Accordingly, if the report of the channel state information 1450 about each of the plurality of subbands is forwarded to the eNB 1420 through the WLAN system (or the AP 1410), system overhead can be reduced.

In contrast, the UE 1400 may transmit the channel state information 1460 about the wideband to the eNB through the WLAN system, and may transmit the channel state information 1450 about each of the plurality of subbands through the cellular system. The channel state information 1460 about the wideband may be reported in a longer period because a change of the channel state information 1460 about the wideband is not greater than that of the channel state information about the subbands.

A method for transmitting control information in a wireless communication system may include the steps of transmitting, by UE, first cellular control information to an eNB on a cellular system and transmitting, by the UE, second cellular control information to the eNB through an AP on a WLAN system. The UE may communicate with the eNB and the AP. The first cellular control information and the second cellular control information may be information for a service for the UE by the eNB. The first cellular control information may include subframe index information indicative of a subframe in which channel state information about a wideband determined based on a radio signal transmitted by the eNB and a reference signal for determining the channel state information about the wideband have been transmitted. The second cellular control information may include subframe index information indicative of a subframe in which channel state information about each of a plurality of subbands included in a wideband determined based on a radio signal transmitted by the eNB and a reference signal for determining the channel state information about each of the plurality of subbands have been transmitted.

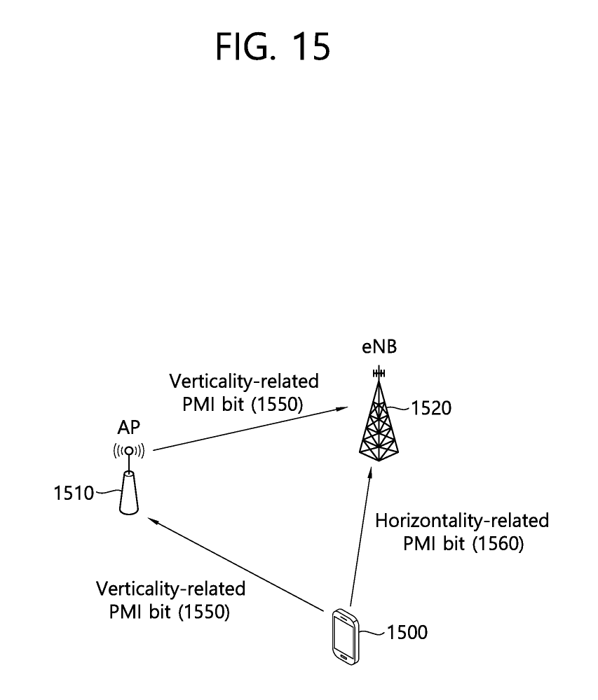

FIG. 15 is a conceptual diagram showing a method for transmitting, by UE, cellular control information through a WLAN system according to an embodiment of the present invention.

FIG. 15 discloses a method for transmitting some of cellular control information through a WLAN system. In particular, PMI information (or a PMI bit) may be divided into verticality-related PMI information (a verticality-related PMI bit) 1550 and horizontality-related PMI information (a horizontality-related PMI bit) 1560. The verticality-related PMI bit 1550 and the horizontality-related PMI bit 1560 may be transmitted to an eNB 1520 through different RATs (a cellular system and a WLAN system).

All of PMI bits indicated by a codebook index for three-dimensional (3D) channels may be divided into the verticality-related PMI bit 1550 and the horizontality-related PMI bit 1560. If all of the PMI bits are 12 bits, the former 8 bits may be the horizontality-related PMI bits 1560, and the remaining 4 bits may be the verticality-related PMI bits 1550.

The horizontality-related PMI bit 1560 may be suddenly changed, but a change of the verticality-related PMI bit 1550 may not be great. The UE 1500 may transmit information about the horizontality-related PMI bit 1560 to the eNB 1520 through a cellular system, and may transmit information about the verticality-related PMI bit 1550 to the eNB 1520 through a WLAN system (or an AP 1510).

In contrast, UE 1500 may transmit the information about the horizontality-related PMI bit 1560 to the eNB 1520 through the cellular system, and may transmit the information about the verticality-related PMI bit 1550 to the eNB 1520 through the WLAN system.

A method for transmitting control information in a wireless communication system may include the steps of transmitting, by UE, first cellular control information to an eNB on a cellular system and transmitting, by the UE, second cellular control information to the eNB through an AP on a WLAN system. The UE may communicate with the eNB and the AP. The first cellular control information and the second cellular control information may be information for a service for the UE by the eNB. The first cellular control information may include subframe index information indicative of a subframe in which a reference signal for determining the horizontality-related PMI bit and horizontality-related PMI bit of all of PMI bits determined based on a radio signal transmitted by the eNB has been transmitted. The second cellular control information may include subframe index information indicative of a subframe in which a reference signal for determining the verticality-related PMI bit and verticality-related PMI bit of all of PMI bits determined based on a radio signal transmitted by the eNB has been transmitted.

In the embodiments disclosed in FIGS. 12 to 15, a method for transmitting channel state information other than information about a rank index (RI) has been disclosed, for convenience of description. However, RI information may also be transmitted from UE to an eNB through a WLAN system. The methods disclosed in FIGS. 12 to 15 may be individually used, but may be combined, and a plurality of the combined methods may be used to transmit control information.

If the methods disclosed in FIGS. 12 to 15 are performed, an eNB, UE, and an AP associated with the UE may operate as follows.

The eNB may transmit configuration information (or channel state report configuration information) for reporting the channel state information of the UE to the UE when the UE supporting both a cellular system and a WLAN system reports the channel state information to the eNB through the WLAN system.

For example, the eNB may transmit a CSI report configuration indicator indicating that the channel state information will be transmitted using which method (e.g., a specific one of the methods for transmitting a channel state through the WLAN system which have been disclosed in FIGS. 12 to 15), a report period, and information about radio resources when the channel state information is reported to the cellular system to the UE as channel state report configuration information for the UE.

Furthermore, the eNB may transmit the channel state report configuration information of the UE to the AP associated with the UE. Specifically, the eNB may transmit a CSI report configuration indicator set in the UE, a report period set in the UE, and information about the amount of information transmitted by the UE when the UE reports the channel state information (or information about time resources (duration) necessary to transmit the channel state information of the UE when the UE reports the channel state information to the eNB through the AP associated with the UE) to the AP associated with the UE.

When channel state information transmitted from the UE to the AP associated with the UE is forwarded from the AP associated with the UE, the eNB may transmit channel state report configuration information, such as that described above, to the AP associated with the UE and the UE and may receive the channel state information from the UE through the WLAN system.

The UE may receive channel state report configuration information from the eNB and may transmit channel state information to the eNB through the WLAN system. For example, the UE may classify channel state information to be transmitted through the WLAN system and channel state information to be transmitted through the cellular system based on the channel state report configuration information. Furthermore, if the UE transmits the channel state information through the WLAN system, the UE performs channel access based on a contention. Accordingly, accurate channel access timing for the transmission of the channel state information of the UE cannot be guaranteed. Accordingly, as described above, the UE may transmit information about the time when a signal (e.g., a CSI-RS) used to generate the channel state information is transmitted (e.g., information about the index of a subframe in which a CSI-RS has been transmitted and the number of a system frame in which the CSI-RS has been transmitted) along with the channel state information. Furthermore, the UE may transmit indicator information (e.g., a UE ID (an IP, a C-RNTI)) of the UE and cell identifier information (e.g., a cell ID (an IP, an ECGI, a PCID)) to the eNB. Furthermore, the UE may indicate information that belongs to information transmitted to the AP associated with the UE and that will be transmitted to the eNB based on a cellular forwarding indicator.

If the AP associated with the UE has information that belongs to data received from the UE and that has to be forwarded to the eNB, it may forward the information to the eNB through the following route.

For example, the AP associated with the UE may forward channel state information, received from the UE, to the eNB through an ePDG, a P-GW, an S-GW. Alternatively, if the AP associated with the UE and the eNB are connected based on a radio access network (RAN) interface, the AP associated with the UE may forward the channel state information to the eNB through the RAN interface.

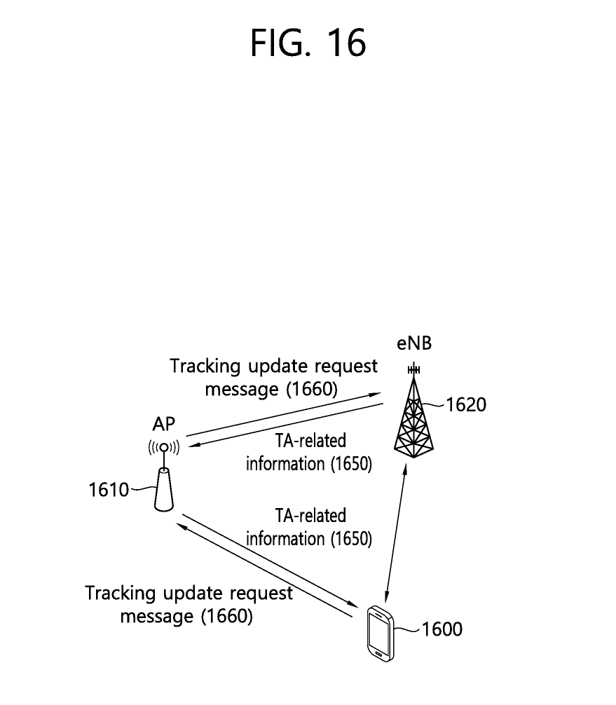

FIG. 16 is a conceptual diagram showing a tracking update method through a WLAN system according to an embodiment of the present invention.

In a cellular system, a tracking area (TA) and a tracking area update (TAU) may be used for the paging of UE in an idle state.

If UE is in an active state (a state in which the UE performs communication or in an (evolved packet system (EPS) mobility management (EMM)-registered/EPS connected management (ECM)-connected/RRC-connected state), an LTE network may be aware of the location of the UE in a cell unit. If the UE is in an idle state (a state in which the UE does not perform communication or in an EMM-Registered/ECM-Idle/RRC-Idle state), the LTE network may be aware of the location of the UE in a tracking area (TA) unit not a cell unit. A communication service provider may define one TA by grouping a plurality of close eNBs.

If traffic to be transmitted to UE in an idle state that does not perform communication is generated, a cellular network may wake the UE of the idle state so that the UE receives data based on paging. The cellular network may transmit a paging message to the UE of the idle state based on a TA. The cellular network needs to always have the latest location information about that the UE of the idle state is placed in which TA. Accordingly, for a tracking area update (TAU), the UE may report a change of the TA over the cellular network through a TAU request message whenever the TA is changed.

UE may receive a TA list when accessing a cellular network. For example, if a TA list of specific UE is {TAC1, TAC2} and the UE is placed within a TA1, a TA2, the UE does not need to transmit a TAU message to an MME. When the UE moves to another place (e.g., a TA3) other than the TA1, the TA2, the UE may transmit a TAU request message to the MME. Furthermore, the MME may transmit an updated TA list to the UE as a response to the TAU request message.

Existing UE may perform a process for RRC establishment with an eNB for a TAU. For a fast TAU, the UE may transmit a TAU request message to the eNB by piggybacking the TAU request message to an RRC connection setup complete message. The UE may perform a tracking area update procedure along with the eNB based on such a process. The UE may switch to idle mode again after terminating the tracking area update procedure. Such an existing tracking area update procedure may generate power consumption of UE.

In accordance with an embodiment of the present invention, in order to reduce power consumption for the tracking area update procedure of UE, idle UE capable of transmitting data through a WLAN system may perform a tracking area update through a WLAN system. In particular, if an AP has mobility, such a tracking area update through a WLAN system may be more effective.

Referring to FIG. 16, TA-related information 1650 of a cellular network may be transmitted and received through an AP 1610. For example, the AP 1610 may transmit the TA-related information 1650 of the cellular network. The AP 1610 may receive the TA-related information 1650 from an eNB 1620 through the backhaul of the cellular network (e.g., a wireless backhaul or a wired backhaul).

The AP 1610 may receive the TA-related information 1650 through the backhaul, and may transmit the TA-related information of the cellular network and information related to cell identifier information (a PCID, an ECGI) to UE 1600 through a specific frame (e.g., a beacon frame).

The UE 1600 that has received the TA-related information 1650 from the AP 1610 through the specific frame may rapidly receive information about whether the TA of the cellular network has been changed. If the received TA is not included in a TA list, the UE 1600 may perform updates on the TA through the AP 1610 without a connection to the cellular network.

Alternatively, in accordance with an embodiment of the present invention, the eNB 1620 may transmit the TA-related information 1650 to the UE 1600 through a system information block (SIB). The UE 1600 that has received the TA-related information from the eNB 1620 through the SIB may detect whether the TA of the cellular network has been changed. If the UE 1600 detects a change of the TA of the cellular network, it may perform updates on the TA through a WLAN system (or the AP 1610). The AP 1610 may transmit information about an indicator that provides notification that a specific cellular TA can be updated and a cell identifier (a cell ID (a PCID, a ECGI) through a beacon frame.

The UE 1600 that has detected a change of the TA of the cellular network (or UE configured to periodically perform a TA report) may transmit a tracking update request message 1660 to the AP 1610 associated with the UE 1600.

The tracking update request message 1660 may include information about an eNB indicator (an eNB ID (a PCID, an ECGI)), an update type, an active flag, a globally unique temporary identifier (GUTI), the last visited tracking area identifier (TAI), a key set identifier access security management entity (KSI_{ASME}), and non-access stratum-message authentication code (NAS-MAC).

The eNB indicator may include the identification information of an eNB that will receive the tracking update request message 1660.

The update type may include information about the type of TAU.

The active flag may be used to indicate whether user data or signaling to be transmitted in UL is present.

The GUTI may indicate information about an UE indicator allocated by an MME.

The GUTI may be used for the MME to identify UE.

The last visited TAI may include information about a TAI that has recently been reported through a TAU request message.

The KSI_{ASME} may include index information about K_{ASME}, that is, an NAS security base key.

The NAS-MAC is an NAS integrity key, and may be message authentication code that has protected a TAU request message with integrity.

The UE 1600 may transmit the tracking update request message 1660 to the eNB (or an interworking entity (IWE)) or an MME through the AP.

For example, the AP 1610 associated with the UE 1600 may forward the tracking update request message 1660, received from the UE 1600, to the eNB 1620 through an ePDG, P-GW or S-GW. Alternatively, if the AP 1610 associated with the UE 1600 and the eNB 1620 are connected based on a radio access network (RAN) interface, the AP 1610 associated with the UE 1600 may forward the tracking update request message 1660 to the eNB 1620 through the RAN interface. Alternatively, the AP 1610 may directly forward the tracking update request message 1660 to an MME.

The eNB (or IWE) 1620 that has received the tracking update request message 1660 from the AP 1610 may transmit an initial UE message to the MME. If the MME accepts a request for a TAU, the MME may transmit a TAU accept message to the eNB (or IWE) 1620 or the AP 1610.

When the eNB (or IWE) 1620 receives the TAU accept message from the MME, the eNB 1620 may forward the TAU accept message to the AP 1610. The AP 1610 that has received the TAU accept message from the eNB 1620 or MME may transmit (or forward) the TAU accept message to the UE 1600. The UE 1600 may check a GUTI and TAU list included in the received TAU accept message, and may update a temporary identification used in next update (TIN) and the TAU list if the TIN and the TAU list are different from previous values.

If a new GUTI is allocated to the UE 1600 by the MME, the UE 1600 may notify the MME that the new GUTI has been received by transmitting a TAU complete message to the MME.

The UE 1600 may notify the MME of the allocation of the new GUTI through various methods. For example, the UE 1600 may notify the MME of the allocation of the new GUTI of the UE 1600 through the AP 1610, an ePDG, a P-GW, a S-GW or the eNB 1620. Alternatively, if the AP 1610 associated with the UE 1600 and the eNB 1620 are connected based on a radio access network (RAN) interface, the AP 1610 associated with the UE 1600 may notify the MME of the allocation of the new GUTI of the UE 1600 through the eNB 1620 based on the RAN interface. Furthermore, the UE 1600 may directly notify the MME of the allocation of the new GUTI of the UE 1600.

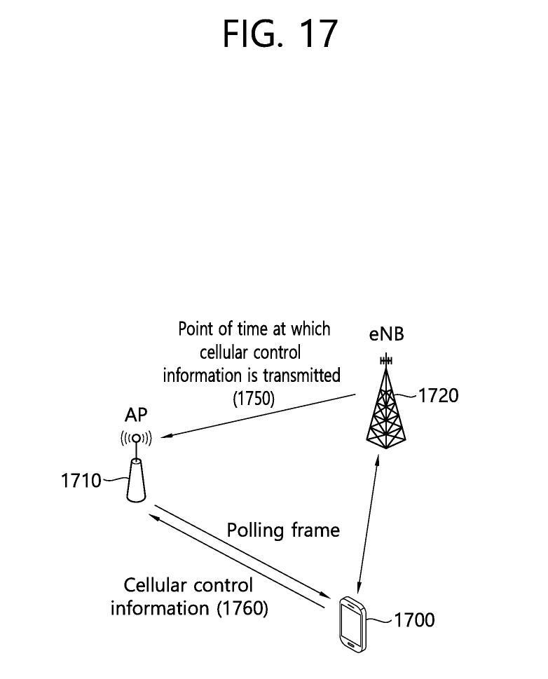

FIG. 17 is a conceptual diagram showing a method for transmitting cellular control information through a WLAN system according to an embodiment of the present invention.

FIG. 17 discloses a method for transmitting cellular control information based on polling in a WLAN system.

Referring to FIG. 17, an AP 1710 may be aware that UE 1700 will transmit cellular control information 1760 to an eNB 1720 through a WLAN system at which point of time based on information received from the eNB 1720. For example, the eNB 1720 may transmit information about a point of time at which the cellular control information 1760 is transmitted through the AP 1710 of the UE 1700 to the AP 1710.

The AP 1710 may determine the transmission interval (or transmission interval or transmission point of time) of cellular control information 1760 of the UE 1700 based on information about a point of time 1750 at which the cellular control information is transmitted, and may poll the transmission of the cellular control information 1760 by the UE.

The transmission interval of the cellular control information 1760 of the UE 1700 may be a specific window interval, and the transmission interval of the cellular control information 1760 of the UE 1700 may be a period (or interval) in which the transmission of the cellular control information 1760 is performed by the UE 1700.

The AP 1710 may poll the UE 1700 on the cellular control information 1760 to be transmitted to the eNB 1720 through the AP 1710 based on polling. The UE 1700 that has received the polling on the cellular control information 1760 from the AP 1710 may transmit the cellular control information 1760 to the AP 1710 if the cellular control information 1760 to be transmitted to the eNB 1720 through the AP 1710 is present.

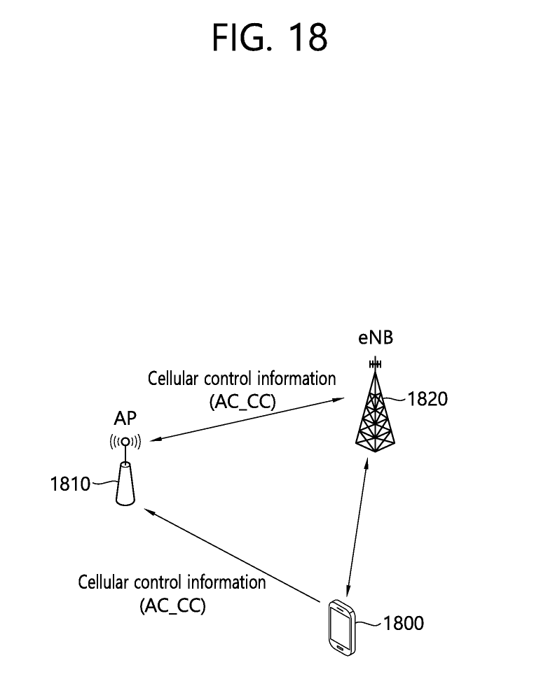

FIG. 18 is a conceptual diagram showing a method for transmitting cellular control information through a WLAN system according to an embodiment of the present invention.

FIG. 18 discloses a method for configuring a routing rule for cellular control information when a WLAN system transmits the cellular control information.

UE 1800 which performs channel access based on EDCA may perform channel access based on a different channel access parameter depending on the access category of traffic.

In accordance with an embodiment of the present invention, the UE 1800 that transmits cellular control information through an AP 1810 may be configured to perform channel access in accordance with a routing rule higher than that of other pieces of UE having traffic data corresponding to different access categories AC_BE, AC_BK, AC_VI, and AC_VO. That is, cellular control information may configured to be preferentially transmitted to the AP 1810 through a channel compared to the data of other access categories based on the configuration of a channel access parameter for the cellular control information. If such a channel access method is used, the cellular control information may be rapidly transmitted to an eNB 1820 through the AP 1810.

For example, the cellular control information may be defined as a new access category AC_CC (access category_cellular control). Channel access parameters CWmin, CWmax, and AIFSN for AC_CC may be newly defined.

Table 2 below shows access category indices (ACIs) for AC_CC.

TABLE 2

| ACI | AC | Description |
|---|---|---|
| 000 | AC_BE | Best effort |
| 001 | AC_BK | Background |
| 010 | AC_VI | Video |
| 011 | AC_VO | Voice |
| 100 | AC_CC | Cellular control |

Referring to Table 2, ‘100’, that is, a new ACI, may be allocated to AC_CC.

Table 3 below shows channel access parameters for AC_CC.

TABLE 3

| AC | CWmin | CWmax | AIFSN |
|---|---|---|---|
| AC_BE | aCWmin | aCWmax | 7 |
| AC_BK | aCWmin | aCWmax | 3 |
| AC_VI | (aCWmin + 1)/2 − 1 | aCWmin | 2 |
| AC_VO | (aCWmin + 1)/4 − 1 | (aCWmin + 1)/2 − 1 | 2 |
| AC_CC | (aCWmin + 1)/8 − 1 | (aCWmin + 1)/4 − 1 | 1 |

Referring to Table 3, AC_CC may have a smaller CWmin, a smaller CWmin or a smaller AIFSN than other access categories. If such a channel access parameter is used for AC_CC, the UE 1800 that pends cellular control information may rapidly perform channel access compared to UE that pends the data of a different access category.

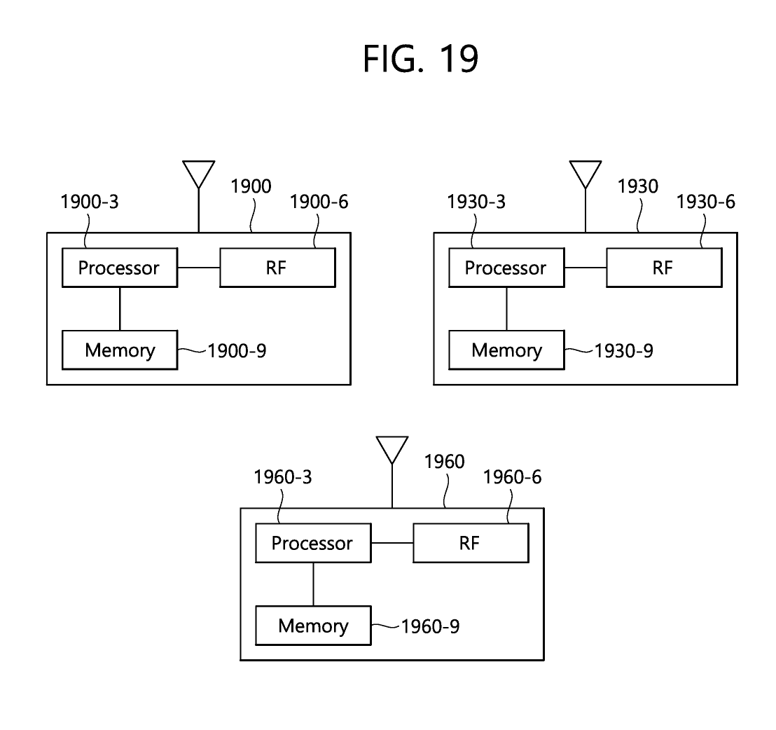

FIG. 19 is a block diagram of a wireless communication system in which an embodiment of the present invention is implemented.

Referring to FIG. 19, a cellular node 1900 includes a processor 1900-3, memory 1900-9, and a radio frequency (RF) unit 1900-6. The cellular node 1900 may be any one of an eNB, an MME, an interworking management entity (IWME), an S-GW, and a P-GW. The processor 1900-3 implements the proposed functions, processes and/or methods. The layers of a radio interface protocol may be implemented by the processor 1900-3. The memory 1900-9 is connected to the processor 1900-3 and stores various pieces of information for driving the processor 1900-3. The RF unit 1900-6 is connected to the processor 1900-3 and transmits and/or radio signals.

Each of the elements of the cellular node 1900 may perform the operations of the eNB, MME, interworking management entity (IWME), S-GW, and P-GW disclosed in the aforementioned embodiments of FIGS. 1 to 18.

For example, the processor 1900-3 may be implemented to transmit measurement configuration information about a measurement target eNB and a measurement target AP to UE. Furthermore, the processor 1900-3 may be implemented to set a measurement report interval in which measurement report information is transmitted to an AP of UE to the AP.

An AP 1930 includes a processor 1930-3, memory 1930-9, and an RF unit 1930-6. The memory 1930-9 is connected to the processor 1930-3, and stores various pieces of information for driving the processor 1930-3. The RF unit 1930-6 is connected to the processor 1930-3 and transmits and/or receives radio signals.

Each of the elements of the AP 1930 may perform the operations the AP 1930 disclosed in the aforementioned embodiments of FIGS. 1 to 18.

For example, the processor 1930-3 may be implemented to transmit cellular control information, received from UE, to the cellular node 1900. Furthermore, the processor 1930-3 may be implemented to forward control information, received from the cellular node, to the UE.

UE 1960 includes a processor 1960-3, memory 1960-9, and an RF unit 1960-6. The memory 1960-9 is connected to the processor 1960-3 and stores various pieces of information for driving the processor 1930-3. The RF unit 1960-6 is connected to the processor 1960-3 and transmits and/or receives radio signals.

Each of the elements of the UE 1960 may perform the operations of the UE 1960 disclosed in the aforementioned embodiments of FIGS. 1 to 18.

For example, the processor 1960-3 may be implemented to transmit first cellular control information to an eNB on a cellular system and to transmit second cellular control information to an eNB on a WLAN system through an AP. Furthermore, the processor 1960-3 may be implemented to communicate with the eNB and the AP through the RF unit 1960-6. The first cellular control information and the second cellular control information may be information for a service for the UE by the eNB.

The processor 1900-3, 1930-3, 1960-3 may include application-specific integrated circuits (ASICs), other chipsets, logic circuits and/or data processing devices. The memory 1900-9, 1930-9, 1960-9 may include read-only memory (ROM), random access memory (RAM), flash memory, a memory card, a storage medium and/or other storage devices. The RF unit 1900-6, 1930-6, 1960-6 may include a baseband circuit for processing a radio signal. When an embodiment is implemented in software, the aforementioned scheme may be implemented as a module (process, function, etc.) which performs the aforementioned functions. The module may be stored in the memory 1900-9, 1930-9, 1960-9 and executed by the processor 1900-3, 1930-3, 1960-3. The memory 1900-9, 1930-9, 1960-9 may be placed inside or outside the processor 1900-3, 1930-3, 1960-3 and connected to the processor 1900-3, 1930-3, 1960-3 by various well-known means.

In the above exemplary systems, although the methods have been described on the basis of the flowcharts using a series of the steps or blocks, the present invention is not limited to the sequence of the steps, and some of the steps may be performed in a sequence from that of the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention.

What is claimed is:

1. A method for transmitting control information in a wireless communication system, comprising steps of:
transmitting, by UE, first cellular control information to an eNB on a cellular system; and
transmitting, by the UE, second cellular control information to the eNB through an access point (AP) on a WLAN system,
wherein the UE is capable of communicating with the eNB and the AP, and
the first cellular control information and the second cellular control information are control information for a service for the UE by the eNB.

2. The method of claim 1, wherein:
the first cellular control information comprises measurement report information about a first measurement target eNB and a first measurement target AP which have transmitted radio signals which belong to radio signals of all of measurement target eNBs and radio signals of all of measurement target APs and which have sizes greater than or equal to a first critical value,
the second cellular control information comprises measurement report information about a second measurement target eNB and a second measurement target AP which have transmitted radio signals which belong to the radio signals of all of the measurement target eNBs and the radio signals of all of the measurement target APs and which have sizes greater than a second critical value and smaller than the first critical value, and
the second cellular control information is transmitted from the UE to the AP on time resources determined based on a measurement report interval set by the eNB.

3. The method of claim 1, wherein:
the first cellular control information comprises best channel information determined based on a radio signal transmitted by the eNB,
the second cellular control information comprises secondary channel information determined based on the radio signal transmitted by the eNB,
the secondary channel information is channel information recommended by the UE next the best channel information,
the first cellular control information comprises subframe index information indicative of a subframe in which a reference signal for determining the best channel information has been transmitted, and
the second cellular control information comprises subframe index information indicative of a subframe in which a reference signal for determining the secondary channel information has been transmitted.

4. The method of claim 3, wherein:
the best channel information comprises at least one of a best channel quality indicator (CQI), a best precoding matrix indicator (PMI), and a best rank indicator (RI), and
the secondary channel information comprises at least one of a secondary CQI, a secondary PMI, and a secondary RI.

5. The method of claim 1, wherein:
the first cellular control information comprises a PMI group index determined based on a radio signal transmitted by the eNB and subframe index information indicative of a subframe in which a reference signal for determining the PMI group index has been transmitted, and
the second cellular control information comprises an individual PMI index determined based on the radio signal transmitted by the eNB and subframe index information indicative of a subframe in which a reference signal for determining the individual PMI index has been transmitted.

6. The method of claim 1, wherein:
the first cellular control information comprises a horizontality-related PMI bit of all of PMI bits determined based on a radio signal transmitted by the eNB and subframe index information indicative of a subframe in which a reference signal for determining the horizontality-related PMI bit has been transmitted, and
the second cellular control information comprises a verticality-related PMI bit of all of the PMI bits determined based on the radio signal transmitted by the eNB and subframe index information indicative of a subframe in which a reference signal for determining the verticality-related PMI bit has been transmitted.

7. The method of claim 1, wherein:
the first cellular control information comprises channel state information about a wideband determined based on a radio signal transmitted by the eNB and subframe index information indicative of a subframe in which a reference signal for determining the channel state information about the wideband has been transmitted, and
the second cellular control information comprises channel state information about each of a plurality of subbands included in the wideband determined based on the radio signal transmitted by the eNB and subframe index information indicative of a subframe in which a reference signal for determining the channel state information about each of the plurality of subbands has been transmitted.

8. UE sending control information in a wireless communication system, the UE comprises:
a radio frequency (RF) unit sending a radio signal; and
a processor operatively connected to the RF unit,
wherein the processor is implemented to transmit first cellular control information to an eNB on a cellular system and to transmit second cellular control information to an eNB through an access point (AP) on a WLAN system,
the processor is implemented to be capable of communication with the eNB and the AP through the RF unit, and
the first cellular control information and the second cellular control information are control information for a service for the UE by the eNB.

9. The UE of claim 8, wherein:
the first cellular control information comprises measurement report information about a first measurement target eNB and a first measurement target AP which have transmitted radio signals which belong to radio signals of all of measurement target eNBs and radio signals of all of measurement target APs and which have sizes greater than or equal to a first critical value,
the second cellular control information comprises measurement report information about a second measurement target eNB and a second measurement target AP which have transmitted radio signals which belong to the radio signals of all of the measurement target eNBs and the radio signals of all of the measurement target APs and which have sizes greater than a second critical value and smaller than the first critical value, and
the second cellular control information is transmitted from the UE to the AP on time resources determined based on a measurement report interval set by the eNB.

10. The UE of claim 8, wherein:
the first cellular control information comprises best channel information determined based on a radio signal transmitted by the eNB,
the second cellular control information comprises secondary channel information determined based on the radio signal transmitted by the eNB,
the secondary channel information is channel information recommended by the UE next the best channel information,
the first cellular control information comprises subframe index information indicative of a subframe in which a reference signal for determining the best channel information has been transmitted, and
the second cellular control information comprises subframe index information indicative of a subframe in which a reference signal for determining the secondary channel information has been transmitted.

11. The UE of claim 10, wherein:
the best channel information comprises at least one of a best channel quality indicator (CQI), a best precoding matrix indicator (PMI), and a best rank indicator (RI), and
the secondary channel information comprises at least one of a secondary CQI, a secondary PMI, and a secondary RI.

12. The UE of claim 8, wherein:
the first cellular control information comprises a PMI group index determined based on a radio signal transmitted by the eNB and subframe index information indicative of a subframe in which a reference signal for determining the PMI group index has been transmitted, and
the second cellular control information comprises an individual PMI index determined based on the radio signal transmitted by the eNB and subframe index information indicative of a subframe in which a reference signal for determining the individual PMI index has been transmitted.

13. The UE of claim 8, wherein:
the first cellular control information comprises a horizontality-related PMI bit of all of PMI bits determined based on a radio signal transmitted by the eNB and subframe index information indicative of a subframe in which a reference signal for determining the horizontality-related PMI bit has been transmitted, and
the second cellular control information comprises a verticality-related PMI bit of all of the PMI bits determined based on the radio signal transmitted by the eNB and subframe index information indicative of a subframe in which a reference signal for determining the verticality-related PMI bit has been transmitted.

14. The UE of claim 8, wherein:
the first cellular control information comprises channel state information about a wideband determined based on a radio signal transmitted by the eNB and subframe index information indicative of a subframe in which a reference signal for determining the channel state information about the wideband has been transmitted, and
the second cellular control information comprises channel state information about each of a plurality of subbands included in the wideband determined based on the radio signal transmitted by the eNB and subframe index information indicative of a subframe in which a reference signal for determining the channel state information about each of the plurality of subbands has been transmitted.
